(19) United States
(12) Patent Application Publication
(10) Pub. No.: US 2023/0104677 A1
(43) Pub. Date: Apr. 6, 2023

(54) THERMOPLASTIC RESIN SUBSTRATE FOR CURVED MIRROR AND METHOD FOR PREPARING THE SAME

(71) Applicant: Covestro Deutschland AG, Leverkusen (DE)

(72) Inventors: Tianxiao Ren, Pudong, Shanghai (CN); Jia Yang, Yuyao City, Zhejiang Province (CN); Yuelin Shi, Yuyao City, Zhejiang Province (CN)

(21) Appl. No.: 17/914,404

(22) PCT Filed: Apr. 6, 2021
(86) PCT No.: PCT/EP2021/058838

§ 371 Date: Sep. 26, 2022

(30) Foreign Application Priority Data
May 8, 2020 (CN) 202010384262.8
Aug. 5, 2020 (EP) 20189589.3

(51) Int. Cl. B29C 45/73; B29D 11/00; B29C 45/00; B29C 33/38

(52) U.S. Cl. CPC B29C 45/73; B29D 11/00596; B29C 45/0001; B29C 33/38; G02B 1/04

(57) ABSTRACT

The present invention relates to a thermoplastic resin substrate for a curved mirror and a method for preparing the same, and a curved mirror and a head-up display comprising the thermoplastic resin substrate. The preparation method comprises the following steps: A) heating up a mold of an injection molding machine to a temperature in a range of 130-190° C. and closing the mold, B) injecting a molten thermoplastic resin into the cavity of the mold cavity, C) applying a pressure of 300-700 bar to the cavity for a period of 5 or more seconds, D) stopping applying pressure and cooling the mold to a temperature in a range of 60-100° C. within 10-50 seconds, and E) opening the mold and taking out the molded thermoplastic resin substrate, wherein a gap of 0.3-1 mm is left between the parting surfaces of the cavity of the mold prior to applying the pressure to the cavity. The thermoplastic resin substrate according to the present invention features a large size, high dimensional stability, and low surface roughness. It can be used for future augmented reality head-up displays to realize large-area, long-distance projection and high-precision imaging, thereby satisfying the requirements for driving safety and comfort of future automobiles.

### TECHNICAL FIELD

The present invention belongs to the field of thermoplastic resin processing. In particular, the present invention relates to a thermoplastic resin substrate for a curved mirror and a method for preparing the same.

### BACKGROUND ART

Head-up displays for automobiles mainly have the following two functions: the first function relates to safety, i.e. head-up displays reduce driver distraction and improve driver safety; the second function relates to more comfortable driving. With all information directly projected in drivers' view, the head-up displays can help the driver to identify and capture critical situations more quickly. As feedback on driving conditions and automobile conditions gets improved, important information will not be missed out.

Head-up displays currently available in the market mainly comprise combiner head-up displays (C-HUP) and front windshield head-up displays (W-HUP). Front windshield head-up displays are increasingly accepted and applied by automotive original equipment manufacturers (OEMs) at home and abroad, and gradually become a standard configuration.

Common front windshield head-up displays can satisfy requirements for an imaging distance of 2-3 meter and a projection area of 40 cm*20 cm.

However, the projection distance and the dimension of the display image of the current front windshield head-up displays still cannot meet the requirements of head-up displays to cope with increasingly complex road environment in the future. For example, a farther projection distance and a longer and wider display image are required to render drivers with a more comfortable field of vision and at the same time provide more information. A new generation of augmented reality head-up displays can directly present virtual information in drivers' view and insert full-color graphics into true street view to generate an image with a width of approximately 130 cm and a height of over 60 cm at a distance of 7.5 meters or more from the drivers' field of vision.

Moreover, increasing requirements for surface roughness and surface accuracy of curved mirrors render the original preparation and processing method no longer applicable to meet precision requirements of a new generation of curved mirrors.

Only large-sized curved mirrors with high dimensional stability and low surface roughness can project a larger image in a farther distance. Compared with a conventional thermoplastic resin substrate for a small-sized curved mirror, the preparation of a thermoplastic resin substrate for a large-sized curved mirror faces the following technical challenges:

1. as the size of the concave mirror increases greatly and the surface area of the concave mirror increases by about 3 times, such large-size design is more prone to stress deformation than the original small-size design;

2. as the head-up display will be installed within the instrument panel and close to the engine, any change in temperature (from a higher temperature to a lower temperature, or vice versa) may lead to a change in dimension caused by thermal expansion and contraction;

3. as the surface area of the concave mirror increases, the requirements for processing polycarbonate (PC) parts with low surface roughness are higher.

US 2014/0356551A1 discloses a thermoplastic shaped product having a high surface quality, which is manufactured by the combination of an injection molding process with dynamic temperature control of the mold and with the aid of reinforced thermoplastic molding compositions.

JP55161621A discloses a concave plate formed by directly applying pressure to a convex mold having a surface roughness of 0.1 μm or less at a mold temperature of 20-40° C. which is lower than the thermal deformation point of a resin. An Al or Cr layer with a thickness of 1,000-9,000A is electrodeposited inside the concave plate to produce a concave mirror.

However, the prior art has yet to provide a large-sized curved mirror with high dimensional stability and low surface roughness.

Therefore, preparation of a large-sized curved mirror with high dimensional stability and low surface roughness is crucial to developing a new generation of augmented reality head-up displays. Furthermore, it is necessary to prepare a substrate for a large-sized curved mirror with high dimensional stability and low surface roughness.

### SUMMARY OF THE INVENTION

One objective of the present invention is to provide a substrate for a large-sized curved mirror with high dimensional stability and low surface roughness.

Another objective of the present invention is to provide a large-sized curved mirror with high dimensional stability and low surface roughness.

Therefore, according to a first aspect, the present invention provides a method for preparing a thermoplastic resin substrate for a curved mirror, comprising the following steps:

A) heating up a mold of an injection molding machine to a temperature in a range of 130-190° C. and closing the mold,

B) injecting a molten thermoplastic resin into the cavity of the mold,

C) applying a pressure of 300-700 bar to the cavity for a period of 5 or more seconds,

D) stopping applying pressure to the cavity and cooling the mold to a temperature in a range of 60-100° C., and

E) opening the mold and taking out the molded thermoplastic resin substrate,

wherein—before conducting step C—a gap of 0.3-1 mm is left between the parting surfaces of the cavity of the mold prior to applying the pressure to the cavity. According to a second aspect, the present invention provides a thermoplastic resin substrate prepared by the method according to the first aspect of the present invention. Preferably, the gap is left open during the time while conducting step A and step B.

According to a third aspect, the present invention provides a thermoplastic resin substrate for a curved mirror, characterized in that:

the substrate has a length of 300-400 mm, a width of 150-300 mm, and a thickness of 3-6 mm, the surface roughness of the substrate is from ≥2 nm to ≤10 nm, wherein for the dimensional stability the following applies:

a) the peak-to-valley (PV) value of the substrate is from ≥2 nm to ≤25 μm (at 25° C.);

b) after storage at 100° C. for 4 hours, the peak-to-valley (PV) value of the substrate is from ≥5 nm to ≤25μm.

A low peak-to-valley (PV) value means means better dimensional stability of the substrate and is therefore desirable.

According to a fourth aspect, the present invention provides a curved mirror comprising the thermoplastic resin substrate according to the third aspect of the present invention.

According to a fifth aspect, the present invention provides a head-up display comprising the curved mirror according to the fourth aspect of the present invention.

The thermoplastic resin substrate according to the present invention features a large size, high dimensional stability, low surface roughness and high rigidity. It can be used for future augmented reality head-up displays to realize large-area, long-distance projection and high-precision imaging, thereby meeting the requirements for driving safety and comfort of future automobiles.

### BRIEF DESCRIPTION OF THE DRAWINGS

The present invention will be exemplarily illustrated in conjunction with the drawings hereinafter, in which:

FIG. 1 shows a schematic diagram of a mold that can be used to implement the method of the present invention, wherein, a: stationary mold plate; b: movable mold plate; c: compression frame; d: flow passage; e: oil cylinder; f: mold cavity; g. parting line.

FIG. 2 shows a schematic diagram of the principle of injection compression molding, wherein, (i): a mold in an open state; (ii): forming a mold cavity; (iii): injection into the mold; (iv): compression molding; (v): opening the mold to take out the molded article.

### DETAILED DESCRIPTION OF THE INVENTION

Each aspect and further objectives, features and advantages of the present invention will be more fully described hereinafter.

Thus, according to the first aspect, the present invention provides a method for preparing a thermoplastic resin substrate for a curved mirror, comprising the following steps:

A) heating up a mold of an injection molding machine to a temperature in a range of 130-190° C. and closing the mold,

B) injecting a molten thermoplastic resin into the cavity of the mold,

C) applying a pressure of 300-700 bar to the cavity for a period of 5 or more seconds,

D) stopping applying pressure to the cavity and cooling the mold to a temperature in a range of 60-100° C., and

E) opening the mold and taking out the molded thermoplastic resin substrate, wherein a gap of 0.3-1 mm is left between the parting surfaces of the cavity of the mold prior to applying the pressure to the cavity.

The inventors of the present invention conducted extensive research to provide a thermoplastic resin substrate for a curved mirror, characterized in that:

the substrate has a length of 300-400 mm, a width of 150-300 mm, and a thickness of 3-6 mm,

the surface roughness of the substrate is ≤10 nm,

wherein for the dimensional stability the following applies:

a) the peak-to-valley (PV) value of the substrate is ≤25 μm (at 25° C.);

b) after storage at 100° C. for 4 hours, the peak-to-valley (PV) value of the substrate is ≤25μm.

With the combination of the thermoplastic resin used, the compression injection molding process, and rapid cooling and heating to control mold temperature, the method according to the present invention solves the dimensional stability issue of large-sized curved mirrors. As such, the curved mirrors have more homogeneous stress distribution during the molding, significantly improved dimensional stability, as well as greatly enhanced surface finish quality.

Preferably, the thermoplastic resin is a mineral-filled polycarbonate or a mineral-filled polycarbonate-polyethylene terephthalate blend.

Preferably, the mineral is selected from talc or quartz.

Preferably, the amount of the mineral is 10-40 wt.%, relative to the total weight of the thermoplastic resin, more preferably 15 to 40 wt.-%.

For a mineral-filled polycarbonate-polyethylene terephthalate (PET) blend, preferably, the weight ratio of polycarbonate to polyethylene terephthalate (PET) ranges from 90:10 to 60:25, more preferably from 90:10 to 60:40.

Preferably, the thermoplastic resin has a relatively low coefficient of linear thermal expansion, which is in a range from 0.4*10⁻⁴ to 0.6*10⁻⁴/K, as measured according to ISO11359-1,-2: 2014. Preferably, the thermoplastic resin has a relatively low molding shrinkage, which is not greater than 0.8%, as measured according to ISO 1133: 2011.

Injection Compression Molding Process:

Injection compression molding is a technology combining injection molding and compression molding, which is also known as injection molding with secondary mold closure.

Injection compression molding can be carried out using existing injection molding machines.

Injection compression molding process mainly comprises two steps, namely, injection into a mold and compression molding.

Injection into a mold: firstly, the mold is closed for the first time, preferably, the movable and stationary mold plates are not completely closed, leaving a gap of a certain distance. As the core of the mold does not have any gap, the melt in the mold cavity will not leak out even if the mold is not completely closed.

Compression molding: when the screw advances until the plasticized amount falls within a range of 50%-100%, the mold is closed for the second time to completely clamp the movable and stationary mold plates; then, the melt in the mold cavity, under compression of the movable mold plate, forms the precise shape of the mold cavity. After the molded article is cured and the pressure on the mold is removed, the mold is opened and the molded article is taken out.

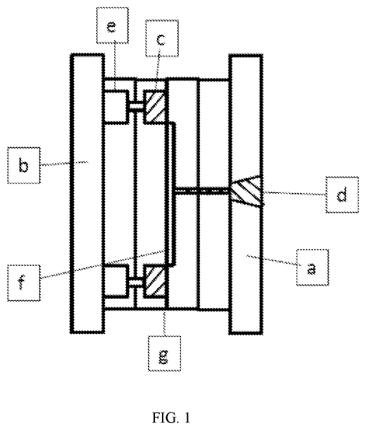

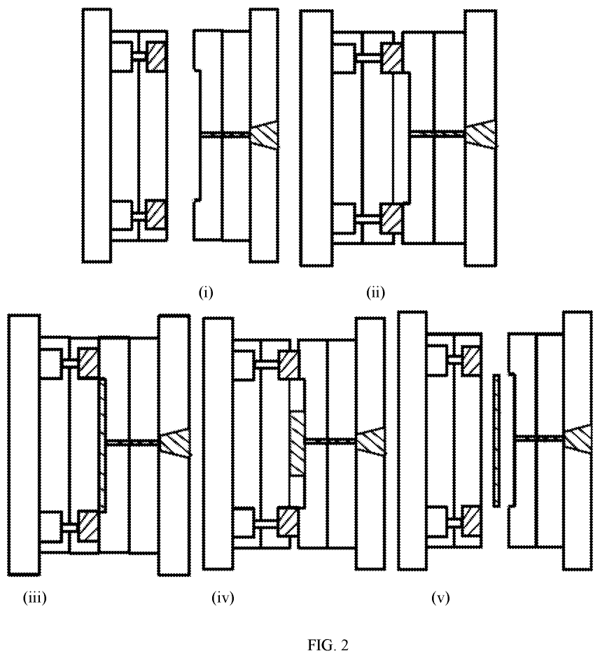

The injection compression molding will be briefly described below with reference to FIGS. 1 and 2. It should be understood that these figures are only illustrative and are not intended to limit the method of the present invention.

FIG. 1 shows a schematic diagram of a mold that can be used to implement the method of the present invention, wherein, a: stationary mold plate; b: movable mold plate; c: compression frame; d: flow passage; e: oil cylinder; f: mold cavity; g. parting line.

FIG. 2 shows a schematic diagram of the principle of injection compression molding, wherein (i): a mold in an open state; (ii): forming a mold cavity; (iii): injection into the mold; (iv):

compression molding; (v): opening the mold to take out the molded article.

FIG. 2 (i) shows the mold in an open state.

FIG. 2 (ii) shows that the movable mold plate b advances and stops at a certain distance from the stationary mold plate a; the compression frame c driven by the oil cylinder e advances to compress against the stationary mold plate a. As a result, a mold cavity f with a variable thickness is formed between the movable mold plate b, the stationary mold plate a, and the compression frame c.

FIG. 2 (iii) shows that the resin melt is injected into the mold cavity f through the flow passage d.

FIG. 2 (iv) shows that, after the resin melt is injected into the mold cavity f or during the injection, the movable mold plate b is completely closed to compress the melt.

FIG. 2 (v) shows that after cooling for a certain period of time, the movable mold plate b is removed and the molded article is taken out.

The time for heating up the mold of the injection molding machine to a temperature in a range of 130-190° C. is not particularly limited, which usually can be determined according to the means of heating up the mold, for example, within a range of 10-200 seconds.

Preferably, a gap of 0.6 mm is left between the parting surfaces of the cavity of the mold prior to applying the pressure to the cavity.

Preferably, when applying the pressure to the cavity is stopped, the gap between the parting surfaces of the mold cavity is no more than 0.1 mm, preferably 0 mm.

Preferably, during step B, when the molten thermoplastic resin is injected into the mold cavity, the holding pressure of the screw is in a range of 50-150 bar, preferably 60-140 bar. As such, the pressure is more homogenously distributed in the cavity, and the product is less likely to be deformed.

Preferably, during step B, the temperature of the molten thermoplastic resin is in a range of 270-310° C.

Preferably, during step C, the pressure is in a range of 300-600 bar.

Preferably, the dwell time is in a range of 5-50 seconds, more preferably 10-40 seconds.

During step D, the time for cooling the mold of the injection molding machine to a temperature in a range of 60-100° C. is not particularly limited, and can generally be determined according to the means of cooling the mold, for example, within a range of 10-150 seconds.

In some embodiments, the thermoplastic resin used is a mineral-filled polycarbonate-polyethylene terephthalate blend, the mold is heated up to a temperature in a range of 130-160° C. during step A, and the mold was cooled to a temperature in a range of 80-90° C. during step D.

In some embodiments, the thermoplastic resin used is a mineral-filled polycarbonate, the mold is heated up to a temperature in a range of 140-190° C. during step A, and the mold is cooled to a temperature in a range of 90-100° C. during step D.

Preferably, the core of the mold has excellent mechanical processing performance, corrosion resistance as well as good polishing property. For example, the core is obtained by subjecting DIN 1.2343 or 1.2343+ mold steel to high-speed milling, surface hardening, and surface polishing. These materials are especially suitable to provide a low surface roughness.

Preferably, the core of the mold has a surface hardness of 50HRC or more.

Preferably, the core of the mold has a surface polishing level of 10 nm or more.

According to the second aspect, the invention provides a thermoplastic resin substrate prepared by the method according to the first aspect of the present invention.

In some embodiments, the thermoplastic resin substrate is characterized in that:

the length is 200-500 mm, the width is 100-350 mm, and the thickness is 3-6 mm,

the surface roughness is ≤10 nm,

wherein for the dimensional stability the following applies:

a) the peak-to-valley (PV) value is ≤25 μm (at 25° C.);

b) after storage at 100° C. for 4 hours, the peak-to-valley (PV) value is ≤25μm.

In some preferred embodiments, the thermoplastic resin substrate is characterized in that:

the length is 200-500 mm, the width is 100-350 mm, and the thickness is 3-6 mm,

the surface roughness ranges from 2 nm to 10 nm,

wherein for the dimensional stability the following applies:

a) the peak-to-valley (PV) value ranges from 2 μm to 25 μm (at 25° C.);

b) after storage at 100° C. for 4 hours, the peak-to-valley (PV) value ranges from 5 μm to 25 μm.

According to the third aspect, the present invention provides a thermoplastic resin substrate for a curved mirror, characterized in that:

the substrate has a length of 300-400 mm, a width of 150-300 mm, and a thickness of 3-6 mm,

the surface roughness of the substrate is ≤10 nm,

wherein for the dimensional stability the following applies:

a) the peak-to-valley (PV) value of the substrate is <25 μm (at 25° C.);

b) after storage at 100° C. for 4 hours, the peak-to-valley (PV) value of the substrate is ≤25 μm.

In some preferred embodiments, the thermoplastic resin substrate for a curved mirror is characterized in that:

the length is 200-500 mm, the width is 100-350 mm, and the thickness is 3-6 mm,

the surface roughness ranges from 2 nm to 10 nm,

wherein for the dimensional stability the following applies:

a) the peak-to-valley (PV) value ranges from 2 μm to 25 μm (at 25° C.);

b) after storage at 100° C. for 4 hours, the peak-to-valley (PV) value ranges from 5 μm to 25 μm.

According to the fourth aspect, the present invention provides a curved mirror comprising the thermoplastic resin substrate according to the third aspect of the present invention.

In addition to the thermoplastic resin substrate according to the third aspect of the present invention, the curved mirror further comprises at least one layer of reflective film disposed on the substrate, the reflective film is selected from the group consisting of an aluminum film, a copper film, and an inorganic non-metallic film.

The inorganic non-metallic film can be the one commonly used for the preparation of curved mirrors in the art.

The reflective film can be applied in a manner commonly used in the art, such as vapor deposition or sputtering.

The reflective film can have a thickness in a range of 30-300 nm.

In some embodiments, the resulting curved mirror has a reflectance ≥85% for visible light in a range of 420-680 nm, as measured with a spectrophotometer.

According to the fifth aspect, the present invention provides a head-up display comprising the curved mirror according to the fourth aspect of the present invention.

The terms “comprising” and “including” described in the present application cover the circumstances which further comprise or include other elements not specifically mentioned and the circumstances consisting of the elements mentioned.

Unless otherwise defined, all technical and scientific terms used herein have the same meaning as commonly understood by a person skilled in the field the present invention belongs to. When the definition of a term in the present description conflicts with the meaning as commonly understood by a person skilled in the field the present invention belongs to, the definition described herein shall apply.

Unless otherwise specified, all numerical values expressing amount of ingredients, reaction conditions and the like used in the description and claims are to be understood as being modified by the term “about”. Accordingly, unless indicated to the contrary, the numerical values and parameters described herein are approximate values which are capable of being changed according to the desired performance obtained as required.

### EXAMPLES

The concept and technical effects of the present invention will be further illustrated below in conjunction with the Examples so that a person skilled in the art can fully understand the objectives, features and effects of the present invention. It shall be understood that the Examples are for illustrative purposes only and the scope of the present invention is not limited thereto.

Description of Main Raw Materials:

PC-1: Common polycarbonate, from Covestro Polymers (China) Co., Ltd.;

PC-2: Filled grade polycarbonate/PET blend, UT235M from Covestro Polymers (China) Co., Ltd.;

PC-3: Filled grade polycarbonate, DS801 from Covestro Polymers (China) Co., Ltd.

The raw materials have the following characterization data:

| Materials | PC-1 | PC-2 | PC-3 |
|---|---|---|---|
| Item | Pure PC | Mineral-filled | Mineral-filled |
| | | PC/PET | PC |
| Density | 1.2 | 1.34 | 1.46 |
| (g/cm³) | | | |
| CLTE*parallel/ | 0.65/0.65 | 0.45/0.45 | 0.45/0.46 |
| lateral (10⁻⁴/K) | | | |
| MVR | 19 (300° C.; | 35 (270° C.; | 10 (300° C.; |
| (cm³/10 min) | 1.2 kg) | 5 kg) | 1.2 kg) |
| Tensile | 2400 | 4500 | 4900 |
| Modulus(MPa) | | | |
| Tensile | 65 | 67 | 63 |
| strength (MPa) | | | |
| Molding | 0.5-0.7 | 0.5-0.6 | 0.32-0.34 |
| shrinkage (%) | | | |

CLTE*: coefficient of linear thermal expansion, measured according to ISO 11359-1, -2: 2014.
MVR**: melt volume-flow rate, measured according to ISO 1133: 2011.
Tensile Modulus and tensile strength: measured according to ISO 527-1, -2: 2012.
Molding shrinkage: measured according to ISO 2577: 2007.

Description of Experimental Devices:

Injection molding machine: Engel 650 injection molding machine.

Mold temperature controller: Single ATT H2-200-48 mold temperature controller.

Injection mold: from Covestro Polymers (China) Co., Ltd., designed according to a concave mirror of 318 mm*140.7 mm*4 mm.

Mold Structure:

1. The mold is a 2-plate mold, with a mirror surface core and a hot flow passage mechanism on the stationary side, and a compression mechanism and an ejection mechanism on the movable side.

2. The compression mechanism adopts the structure of a compression frame, and uses an oil cylinder to control the advancement and retreat of the compression frame. The maximum travel distance is 5 mm. The oil cylinder can provide 40 tons of clamping force to seal the mold cavity. Such compression mechanism coordinates with an injection molding program of the injection molding machine to perform injection molding.

3. The core of the mold is made of DIN 1.2343 mold steel, which has excellent mechanical processing performance, corrosion resistance as well as good polishing property. The polishing level of the core surface can reach a level of 10 nm or more.

4. The polished core surface is hardened so that the steel has a surface hardness of 50HRC. In this way, the steel can resist abrasion of the polished surface by the plastic melt during the molding process.

5. The cores of the movable mold plate and the stationary plate are equipped with water passages capable of handling rapid cooling and heating. The water passages satisfy the high temperature and high pressure conditions of 200° C./22 bar.

Method for Optical Detection:

(1) The PV value of the curved mirror was measured with a structured light scanner as follows:

A Fuma surface profile analyzer was used, which can scan the surface of the part with sinusoidal light, calculate the surface information based on the phase change of the sinusoidal light reflected from the surface of the part, and compare it with the theoretical surface information of the part to obtain part final surface value and RMS value.

Testing conditions: under room temperature (20° C.) and humidity of 45% RH.

Testing process: the sample was placed in a special tooling, the test was initiated by clicking the testing button, the testing screen emitted sinusoidal light, and received the sinusoidal light reflected from the surface of the part, and demodulated its phase information to calculate the surface information, then the corresponding PV value & RMS value can be obtained with a analysis software of the analyzer;

(2) The surface roughness of the curved mirror was measured with a white light interferometer as follows.

A surface roughness analyzer was used to scan the surface of the part using the interference method and determine the surface quality of the part according to the number of light and dark stripes;

(3) The reflectance for visible light in a range of 420-680 nm was measured with a Lamda750 spectrophotometer as follows.

Testing process: a beam of laser with constant energy was emitted from a laser light source, passed through a inherent light path, and hit the surface of the sample to be tested for reflection. A receiver received the reflected light and recorded the received energy value. The reflectivity can be expressed as receiving light energy/outgoing light energy*100%.

### Comparative Example 1 (CE1)

PC-1 resin was placed in a dehumidifying dryer to be dried at the temperature of 120° C. for 4 hours to reduce the moisture content of the PC-1 resin to 0.01 wt. % or less.

A mold designed for a 7 mm-thick thermoplastic resin substrate was used.

First, the mold of the injection molding machine was heated up to a temperature in a range of 100-110° C., and then closed for the first time, leaving a gap of 0.6 mm between the parting surfaces of the mold cavity. Then, the PC-1 resin molten at 280-300° C. was injected into the mold cavity, with the holding pressure of the screw being 65 bar. A pressure of 600 bar was applied to the cavity and maintained for a period of 30 seconds. At this time, the gap between the parting surfaces of the mold cavity was 0 mm. Then, the cavity was no longer applied with pressure and cooled to a temperature in a range of 80-90° C. within a period of 20 seconds. The mold was opened and the molded thermoplastic resin substrate was taken out.

The parameters used in the preparation process of the substrate were summarized in Table 1.

The substrate was dried at 100° C. for 4 hours, and then blown with an ionizer gun for 5 seconds. Before and after being dried, the substrate was subjected to optical tests, and the results were summarized in Table 2.

Next, vapor deposition was carried out at a temperature of 40-105° C. and a vacuum degree of 2*10E^{-3-3*10}E⁻³. The film layer was a metal aluminum film with a thickness of 150 nm. After completion of vapor deposition, a curved mirror was obtained.

### Comparative Example 2 (CE2)

Comparative Example 2 was carried out with reference to Comparative Example 1, except that a mold designed for a 4 mm-thick thermoplastic resin substrate was used, and the holding pressure of the screw was 130 bar.

The parameters used in the preparation process of the substrate were summarized in Table 1.

The optical test results of the resulting substrate and curved mirror were summarized in Table 2.

### Comparative Example 3 (CE3)

Comparative Example 3 was carried out with reference to Comparative Example 1, except that a mold designed for a 4 mm-thick thermoplastic resin substrate was used.

The parameters used in the preparation process of the substrate were summarized in Table 1.

The optical test results of the resulting substrate and curved mirror were summarized in Table 2.

### Example 1 (E1)

PC-2 resin was placed in a dehumidifying dryer to be dried at the temperature of 120° C. for 4 hours to reduce the moisture content of the PC-2 resin to 0.01 wt. % or less.

A mold designed for a 4 mm-thick thermoplastic resin substrate was used.

First, the mold of the injection molding machine was heated up to a temperature in a range of 140-160° C., and then closed for the first time, leaving a gap of 0.6 mm between the parting surfaces of the mold cavity. Then, the PC-2 resin molten at 270-290° C. was injected into the mold cavity, with the holding pressure of the screw being 130 bar. A pressure of 600 bar was applied to the cavity and maintained for a period of 30 seconds. At this time, the gap between the parting surfaces of the mold cavity was 0 mm. Then, the cavity was no longer applied with pressure and cooled to a temperature in a range of 80-90° C. within a period of 40 seconds. The mold was opened and the molded thermoplastic resin substrate was taken out.

The substrate was dried at 100° C. for 4 hours, and then blown with an ionizer gun for 5 seconds.

Before and after being dried, the substrate was subjected to optical tests, and the results were summarized in Table 2.

Next, vapor deposition was carried out at a temperature of 40-105° C. and a vacuum degree of 2*10E^{-3-3*10}E⁻³. The film layer was a metal aluminum film with a thickness of 150 nm. After completion of vapor deposition, a curved mirror was obtained.

The resulting curved mirror was subjected to optical tests, and the results were summarized in Table 2.

### Example 2 (E2)

Example 2 was carried out with reference to Example 1, except that the holding pressure of the screw was 65 bar.

The parameters used in the preparation process of the substrate were summarized in Table 1.

The optical test results of the resulting substrate and curved mirror were summarized in Table 2.

### Comparative Example 4 (CE4)

PC-2 resin was placed in a dehumidifying dryer to be dried at the temperature of 120° C. for 4 hours to reduce the moisture content of the PC-2 resin to 0.01 wt. % or less.

A mold designed for a 4 mm-thick thermoplastic resin substrate was used.

First, the mold of the injection molding machine was heated up to a temperature in a range of 140-160° C., and then completely closed. Then, the PC-2 resin molten at 270-290° C. was injected into the mold cavity, with the holding pressure of the screw being 65 bar. This was maintained for a period of 30 seconds. Then, the cavity was cooled to a temperature in a range of 80-90° C. within a period of 40 seconds. The mold was opened and the molded thermoplastic resin substrate was taken out.

The parameters used in the preparation process of the substrate were summarized in Table 1.

The substrate was dried at 100° C. for 4 hours, and then blown with an ionizer gun for 5 seconds.

Before and after being dried, the substrate was subjected to optical tests, and the results were summarized in Table 2.

Next, vapor deposition was carried out at a temperature of 40-105° C. and a vacuum degree of 2*10E^{-3-3*10}E⁻³. The film layer was a metal aluminum film with a thickness of 150 nm. After completion of vapor deposition, a curved mirror was obtained.

### Comparative Example 5 (CE5)

Comparative Example 5 was carried out with reference to Example 1, except that a mold designed for 7 mm-thick thermoplastic resin substrate was used and the holding pressure of the screw was 65 bar.

The parameters used in the preparation process of the substrate were summarized in Table 1.

The optical test results of the resulting substrate and curved mirror were summarized in Table 2.

### Example 3 (E3)

Before PC-3 resin was melted and injected into a mold, it was placed in a dehumidifying dryer to be dried at the temperature of 120° C. for 4 hours to reduce the moisture content of the PC-3 resin to 0.01 wt. % or less.

A mold designed for a 4 mm-thick thermoplastic resin substrate was used.

First, the mold of the injection molding machine was heated up to a temperature in a range of 160-180° C., and then closed for the first time, leaving a gap of 0.6 mm between the parting surfaces of the mold cavity. Then, the PC-3 resin molten at 280-300° C. was injected into the mold cavity, with the holding pressure of the screw being 130 bar. A pressure of 600 bar was applied to the cavity and maintained for a period of 30 seconds. At this time, the gap between the parting surfaces of the mold cavity was 0 mm. Then, the cavity was no longer applied with pressure and cooled to a temperature in a range of 80-90° C. within a period of 60 seconds. The mold was opened and the molded thermoplastic resin substrate was taken out.

The parameters used in the preparation process of the substrate were summarized in Table 1.

The substrate was dried at 100° C. for 4 hours, and then blown with an ionizer gun for 5 seconds.

Before and after being dried, the substrate was subjected to optical tests, and the results were summarized in Table 2.

Next, vapor deposition was carried out at a temperature of 40-105° C. and a vacuum degree of 2*10E^{-3-3*10}E⁻³. The film layer was a metal aluminum film with a thickness of 150 nm. After completion of vapor deposition, a curved mirror was obtained.

The resulting curved mirror was subjected to optical tests, and the results were summarized in Table 2.

### Example 4 (E4)

Example 4 was carried out with reference to Example 3, except that the holding pressure of the screw was 65 bar.

The parameters used in the preparation process of the substrate were summarized in Table 1.

The optical test results of the resulting substrate and curved mirror were summarized in Table 2.

### Comparative Example 6 (CE6)

Before PC-3 resin was melted and injected into a mold, it was placed in a dehumidifying dryer to be dried at the temperature of 120° C. for 4 hours to reduce the moisture content of the PC-3 resin to 0.01 wt. % or less.

A mold designed for a 4 mm-thick thermoplastic resin substrate was used.

First, the mold of the injection molding machine was heated up to a temperature in a range of 160-180° C., and then completely closed. Then, the PC-3 resin molten at 280-300° C. was injected into the mold cavity, with the holding pressure of the screw being 65 bar. This was maintained for a period of 30 seconds. Then, the cavity was cooled to a temperature in a range of 90-100° C. within a period of 60 seconds. The mold was opened and the molded thermoplastic resin substrate was taken out.

The parameters used in the preparation process of the substrate were summarized in Table 1.

The substrate was dried at 100° C. for 4 hours, and then blown with an ionizer gun for 5 seconds.

Before and after being dried, the substrate was subjected to optical tests, and the results were summarized in Table 2.

Next, vapor deposition was carried out at a temperature of 40-105° C. and a vacuum degree of 2*10E^{-3-3*10}E⁻³. The film layer was a metal aluminum film with a thickness of 150 nm. After completion of vapor deposition, a curved mirror was obtained.

TABLE 1
Main process parameters used in the Examples

| | | | | | | Holding | | Injection Compression Molding | | | |
|---|---|---|---|---|---|---|---|---|---|---|---|
| | | | | Melting | Mold | pressure | | Mold | Start of | End of | |
| | | Thickness | Molding | temperature | temperature | of screw | Dwell | compressive | Compression | compression | Compression |
| Ex | Material | (mm) | method | (° C.) | (° C.) | (bar) | time(s) | force(bar)* | (mm) | (mm) | time (s) |
| CE1 | PC-1 | 7 | ICM | 280-300 | 100-110 | 65 | 30 | 3500 | 0.6 | 0 | 30 |
| CE2 | PC-1 | 4 | ICM | 280-300 | 100-110 | 130 | 30 | 3500 | 0.6 | 0 | 30 |
| CE3 | PC-1 | 4 | ICM | 280-300 | 100-110 | 65 | 30 | 3500 | 0.6 | 0 | 30 |
| E1 | PC-2 | 4 | ICM | 270-290 | 140-160 | 130 | 30 | 3500 | 0.6 | 0 | 30 |
| E2 | PC-2 | 4 | ICM | 270-290 | 140-160 | 65 | 30 | 3500 | 0.6 | 0 | 30 |
| CE4 | PC-2 | 4 | IM | 270-290 | 140-160 | 65 | 30 | — | 0 | 0 | — |
| CE5 | PC-2 | 7 | ICM | 270-290 | 140-160 | 65 | 30 | 3500 | 0.6 | 0 | 30 |
| E3 | PC-3 | 4 | ICM | 280-300 | 160-180 | 130 | 30 | 3500 | 0.6 | 0 | 30 |
| E4 | PC-3 | 4 | ICM | 280-300 | 160-180 | 65 | 30 | 3500 | 0.6 | 0 | 30 |
| CE6 | PC-3 | 4 | IM | 280-300 | 160-180 | 65 | 30 | — | 0 | 0 | — |

*Applying a mold compressive force of 3500 bar corresponds to applying a pressure of 600 bar to the cavity.

TABLE 2
Optical test results of the thermoplastic resin substrate and the curved mirror coated with a film

| | | Substrate for curved mirror | | | | | Curved mirror | |
|---|---|---|---|---|---|---|---|---|
| | | | | | | PV value after | | Reflectance for |
| | | | | | Surface | treatment | Surface | visible light in |
| | | Thickness | Molding | PV value | roughness | at100° C. for | roughness | a range of |
| Ex | Material | (mm) | method | (μm) | (nm) | 4 hours (μm) | (nm) | 420-680 nm |
| CE1 | PC-1 | 7 | ICM | —** | 2-4 | —** | 3-5 | ≥90% |
| CE2 | PC-1 | 4 | ICM | —** | 2-4 | —** | 3-5 | ≥90% |
| CE3 | PC-1 | 4 | ICM | —** | 2-4 | —** | 3-5 | ≥90% |
| E1 | PC-2 | 4 | ICM | 16 | 2-10 | 16 | 4-9 | ≥90% |
| E2 | PC-2 | 4 | ICM | 2 | 2-10 | 20 | 4-9 | ≥90% |
| CE4 | PC-2 | 4 | IM | —** | 2-10 | —** | 4-9 | ≥90% |
| CE5 | PC-2 | 7 | ICM | —** | 2-10 | —** | 4-9 | ≥90% |
| E3 | PC-3 | 4 | ICM | 5 | 2-10 | 25 | 4-9 | ≥90% |
| E4 | PC-3 | 4 | ICM | 12 | 2-10 | 9 | 4-9 | ≥90% |
| CE6 | PC-3 | 4 | IM | —** | 2-10 | —** | 4-9 | ≥90% |

—** indicates the value exceeds 25 μm.

With a comparison between Example 1 (E1) and Example 2 (E2), it can be seen that the surface shape of the curved mirror manufactured from the mineral-filled PC/PET blend is not easily affected by molding process parameters. For example, when the holding pressure varies greatly, there is little change to the surface shape of the curved mirror. It shows that the molding process window of the filled grade PC blend is very broad and can ensure excellent dimensional stability during the mass production process.

With a comparison between Example 3 (E3) and Example 4 (E4), it can be seen that the surface shape of the curved mirror manufactured from the filled grade PC is not easily affected by the molding process parameters. For example, when the holding pressure varies greatly, there is little change to the surface shape of the curved mirror. It shows that the molding process window of the filled grade PC is very broad and can ensure excellent dimensional stability during the mass production process.

Although some aspects of the present invention have been demonstrated and discussed, a person skilled in the art should realize that changes can be made to the above aspects without departing from the principles and spirit of the present invention. Therefore, the scope of the present invention will be defined by the claims and the equivalents thereof.

1. A method for preparing a thermoplastic resin substrate for a curved mirror, comprising the following steps:
A) heating up a mold of an injection molding machine to a temperature in a range of 130-190° C. and closing the mold,
B) injecting a molten thermoplastic resin into the cavity of the mold,
C) applying a pressure of 300-700 bar to the cavity for a period of 5 or more seconds,
D) stopping applying pressure to the cavity and cooling the mold to a temperature in a range of 60-100° C., and
E) opening the mold and taking out the molded thermoplastic resin substrate, wherein a gap of 0.3-1 mm is left between the parting surfaces of the cavity of the mold prior to applying the pressure to the cavity.

2. The method according to claim 1, wherein the thermoplastic resin is a mineral-filled polycarbonate material or a mineral-filled polycarbonate-polyethylene terephthalate blend, having a linear thermal expansion coefficient in a range from 0.4*10⁻⁴ to 0.6*10⁻⁴/K and/or a molding shrinkage not greater than 0.8%.

3. The method according to claim 2, wherein the mineral is selected from talc or quartz, wherein the amount of the mineral is 10-40 wt. %, relative to the total weight of the thermoplastic resin.

4. The method according to claim 2, wherein the thermoplastic resin is a mineral-filled polycarbonate-polyethylene terephthalate blend wherein the weight ratio of polycarbonate to polyethylene terephthalate (PET) ranges from 90:10 to 60:40.

5. The method according to claim 1, to wherein, when applying the pressure to the cavity is stopped, the gap between the parting surfaces of the mold cavity is no more than 0.1 mm, preferably 0 mm.

6. The method according to claim 1, wherein during step B, when the molten thermoplastic resin is injected into the mold cavity, the holding pressure of the screw is in a range of 50-150 bar.

7. The method according to claim 1, wherein the thermoplastic resin is a mineral-filled polycarbonate-polyethylene terephthalate blend, during step A, the mold is heated up to a temperature in a range of 130-160° C., and during step D, the mold is cooled to a temperature in a range of 80-90° C.

8. The method according to claim 1, wherein the thermoplastic resin is mineral-filled polycarbonate, the mold is heated up to a temperature in a range of 140-190° C. during step A, the mold is cooled to a temperature in a range of 90-100° C. during step D.

9. The method according to claim 1, wherein the core of the mold is manufactured from DIN 1.2343 or 1.2343+ mold steel.

10. The method according to claim 1, wherein the core of the mold has a surface hardness of 50 HRC or more.

11. A thermoplastic resin substrate prepared by the method according to claim 1.

12. The thermoplastic resin substrate of claim 11, characterized in that:
the length is 200-500 mm, the width is 100-350 mm, and the thickness is 3-6 mm,
the surface roughness is ≤10 nm,
wherein for the dimensional stability the following applies:
a) the peak-to-valley (PV) value is <25 μm (at 25° C.);
b) after storage at 100° C. for 4 hours, the peak-to-valley (PV) value is ≤25 μm.

13. A thermoplastic resin substrate for a curved mirror, characterized in that:
the substrate has a length of 300-400 mm, a width of 150-300 mm, and a thickness of 3-6 mm,
the surface roughness of the substrate is ≤10 nm,
wherein for the dimensional stability the following applies:
a) the peak-to-valley (PV) value of the substrate is <25 μm (at 25° C.);
b) after storage at 100° C. for 4 hours, the peak-to-valley (PV) value of the substrate is ≤25 μm.

14. A curved mirror, comprising the thermoplastic resin substrate according to claim 12.

15. A head-up display, comprising the curved mirror according to claim 14.

16. A method for preparing a thermoplastic resin substrate for a curved mirror, comprising the following steps:
A) heating up a mold of an injection molding machine to a temperature in a range of 130-190° C. and closing the mold,
B) injecting a molten thermoplastic resin into the cavity of the mold, the holding pressure of the screw being in a range of 50-150 bar,
C) applying a pressure of 300-700 bar to the cavity for a period of 5 to 50 seconds,
D) stopping applying pressure to the cavity and cooling the mold to a temperature in a range of 60-100° C., wherein, when applying the pressure to the cavity is stopped, the gap between the parting surfaces of the mold cavity is no more than 0.1 mm,
and
E) opening the mold and taking out the molded thermoplastic resin substrate, wherein a gap of 0.3-1 mm is left between the parting surfaces of the cavity of the mold prior to applying the pressure to the cavity, and wherein the thermoplastic resin is a mineral-filled polycarbonate material or a mineral-filled polycarbonate-polyethylene terephthalate blend.
